(19) United States
(12) Patent Application Publication
(10) Pub. No.: US 2012/0138419 A1
(43) Pub. Date: Jun. 7, 2012

(54) LAYOUT FOR PARKING SYSTEM OF DECELERATOR FOR ELECTRIC MOTOR VEHICLE

(75) Inventors: Kyungha Kim, Yongin (KR); Min Sung Kim, Seoul (KR); Jinsook Lee, Uijeongbu (KR); Yeonho Kim, Suwon (KR); Wan Soo Kim, Hwaseong (KR)

(73) Assignees: KIA MOTORS CORPORATION, Seoul (KR); HYUNDAI MOTOR COMPANY, Seoul (KR)

(21) Appl. No.: 13/189,762

(22) Filed: Jul. 25, 2011

(30) Foreign Application Priority Data
Dec. 3, 2010 (KR) 10-2010-0123050

(51) Int. Cl. F16H 61/22

(52) U.S. Cl. 192/219.5

(57) ABSTRACT

A layout for parking system of decelerator for an electric motor vehicle is provided herein. More specifically, the layout includes a decelerator housing, an input gear disposed within the decelerator housing, an output gear disposed within the decelerator housing, an intermediating gear connecting the input gear and the output gear and a parking unit disposed above the input gear and selectively trammeling the intermediating gear. Further, in the present layout the parking unit is disposed above an oil line in the decelerator housing.

### CROSS-REFERENCE TO RELATED APPLICATION

This application claims priority to and the benefit of Korean Patent Application No. 10-2010-0123050 filed in the Korean Intellectual Property Office on Dec. 3, 2010, the entire contents of which are incorporated herein by reference.

### BACKGROUND OF THE INVENTION

(a) Field of the Invention

The present invention relates to a parking system. More particularly, the present invention relates to a layout for parking system of decelerator for an electric motor vehicle.

(b) Description of the Related Art

In general, a parking mechanism is mounted in a decelerator. When a driver manipulates a shift lever, a sprag is engaged with a parking gear by a cam mounted on a parking rod to thus restrain the wheel from rotating. However, a typical parking mechanism brings about an increase in the size of peripheral parts, such as a case or housing, due to the overall size of the parking mechanism, and adds weight and cost to the vehicle as a whole. Moreover, as the typical parking mechanism is disposed at a lower position, this increases the length of a manual shaft and results in a higher torsion torque. Thus, the operability is decreased and the outer diameter of a shaft becomes larger.

In addition, a parking state between a gear and sprag teeth may be released in view of the structures of the parking rod and a detent lever fixing mechanism. Also, since the parking mechanism is submerged in oil, churning may induce power loss and engaged gears may be released due to sliding.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a layout for parking system of decelerator for an electric motor vehicle having advantages of improving layout of a parking unit and gears within a decelerator and reducing total size of the parking system.

The present invention may also reduce power loss induced by churning by disposing a parking unit above oil in the parking mechanism. Compact construction of the decelerator may be possible by reduction of shaft length and layout change, and total weight and manufacturing cost of the parking system may be possible.

A layout for parking system of decelerator for an electric motor vehicle may, according to an exemplary embodiment of the present invention, include a decelerator housing, an input gear disposed within the decelerator housing, an output gear disposed within the decelerator housing, an intermediating gear connecting the input gear and the output gear, and a parking unit disposed above the input gear and selectively trammeling the intermediating gear.

The input gear, intermediating gear and the output gear may be disposed as the input gear, intermediating gear and the output gear in series, and centers of the input gear, intermediating gear and the output gear may be disposed from the bottom upward as the centers of the output gear, the input gear and the intermediating gear in series.

The parking unit may include a manual lever, a detent lever coupled to the manual lever and selectively rotating with the manual lever, a parking rod coupled to the detent lever and provided to be movable with the rotation of the detent lever in the longitudinal direction of the detent lever, a parking rod cam provided on the parking rod, a parking rod spring provided on the parking rod and elastically supporting the parking rod, a parking gear connected to the intermediating gear, a sprag hinged to the decelerator housing and engaged with the parking gear with longitudinal movement of the parking rod cam and a sprag spring elastically supporting the sprag.

The detent lever may be provided with a detent formed to an end of the detent lever, and the layout for parking system may further include a detent spring which elastically fixes the detent and is shaped as a plate shape. A first protrude portion may be integrally formed to the parking rod for preventing the detent lever from separated. A second protrude portion may be integrally formed to the parking rod for supporting the parking rod spring. The parking unit may be disposed so that it is not submerged within oil, which is filled within the decelerator housing.

### BRIEF DESCRIPTION OF THE DRAWINGS

FIG. 1 is a front view showing a layout for parking system of decelerator for an electric motor vehicle according to an exemplary embodiment of the present invention.

FIG. 2 is a perspective view showing a parking unit of a layout for parking system of decelerator for an electric motor vehicle according to an exemplary embodiment of the present invention.

FIG. 3 is a perspective view showing a detent lever of a layout for parking system of decelerator for an electric motor vehicle according to an exemplary embodiment of the present invention.

FIG. 4 is an another perspective view showing a detent lever of a layout for parking system of decelerator for an electric motor vehicle according to an exemplary embodiment of the present invention.

FIG. 5 is a perspective view showing a parking rod of a layout for parking system of decelerator for an electric motor vehicle according to an exemplary embodiment of the present invention.

### DESCRIPTION OF SYMBOLS

10: decelerator housing
20: input gear
30: output gear
40: intermediating gear
50: parking unit
52: manual lever
54: detent lever
56: detent
58: detent spring
60: parking rod
62: parking rod cam
64: parking rod spring
66: first protrude portion
68: second protrude portion
70: parking gear
80: sprag
82: sprag spring

### DETAILED DESCRIPTION OF THE EMBODIMENTS

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

An exemplary embodiment of the present invention will hereinafter be described in detail with reference to the accompanying drawings.

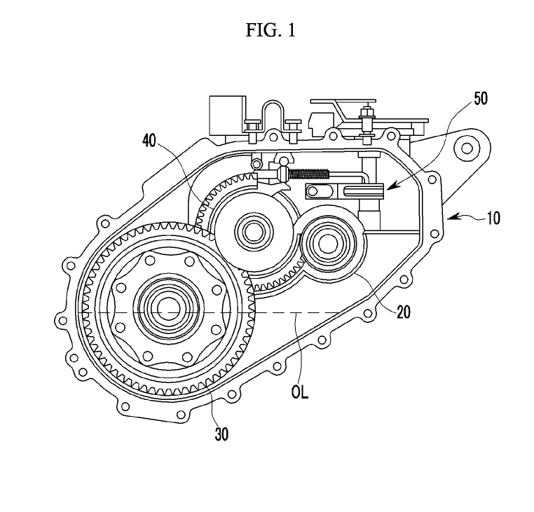

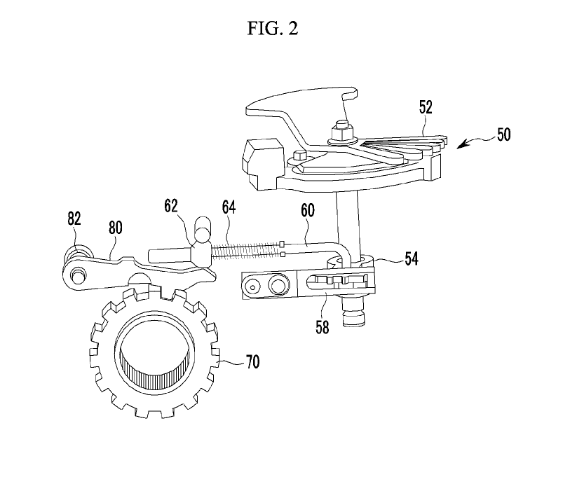

FIG. 1 is a front view showing a layout for parking system of decelerator for an electric motor vehicle according to an exemplary embodiment of the present invention and FIG. 2 is a perspective view showing a parking unit of a layout for parking system of decelerator for an electric motor vehicle according to an exemplary embodiment of the present invention.

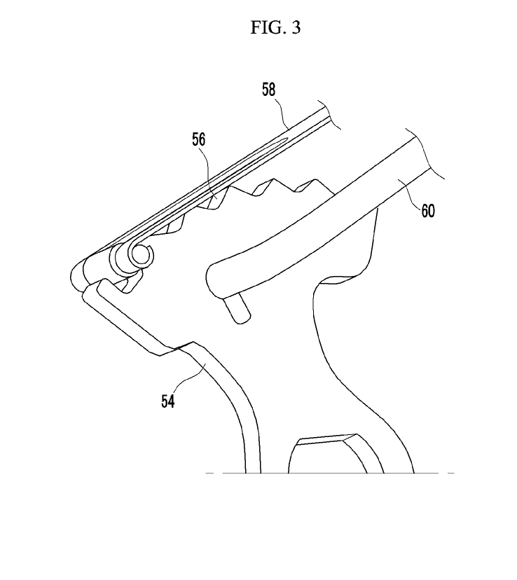

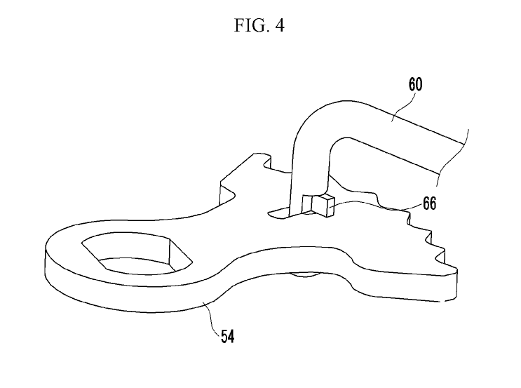

FIG. 3 is a perspective view showing a detent lever of a layout for parking system of decelerator for an electric motor vehicle according to an exemplary embodiment of the present invention and FIG. 4 is an another perspective view showing a detent lever of a layout for parking system of decelerator for an electric motor vehicle according to an exemplary embodiment of the present invention.

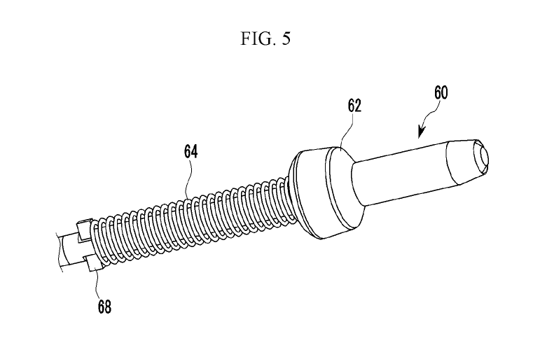

FIG. 5 is a perspective view showing a parking rod of a layout for parking system of decelerator for an electric motor vehicle according to an exemplary embodiment of the present invention.

Referring to FIG. 1 to FIG. 5, a layout for parking system of a decelerator for an electric motor vehicle according to an exemplary embodiment of the present invention includes a decelerator housing 10, an input gear 20 disposed within the decelerator housing 10, an output gear 30 disposed within the decelerator housing 10, an intermediating gear 40 connecting the input gear 20 and the output gear 30 and a parking unit 50 disposed above the input gear 20 and selectively trammeling the intermediating gear 50.

The input gear 20, intermediating gear 40 and the output gear 30 are disposed as the input gear 20, intermediating gear 40 and the output gear 30 in series, and centers of the input gear 20, intermediating gear 40 and the output gear 30 are disposed from the bottom upward as to the centers of the output gear 30, the input gear 20 and the intermediating gear 40 in series.

The layout of the parking unit 50 and the gears as shown in FIG. 1 may induce reduction volume of the decelerator housing 10. Additionally, in the present layout, the parking unit 50 is not submerged within oil so that power loss due to churning of oil may be prevented.

The parking unit 50, referring to FIG. 2, includes a manual lever 52, a detent lever 54 coupled to the manual lever 52 and selectively rotating with the manual lever 52, a parking rod 60 coupled to the detent lever 54 and provided to be movable with the rotation of the detent lever 54 in the longitudinal direction of the detent lever 54, a parking rod cam 62 provided on the parking rod 60, a parking rod spring 64 provided on the parking rod 60 and elastically supporting the parking rod 60, a parking gear 70 connected to the intermediating gear 40, a sprag 80 hinged to the decelerator housing 10 and engaged with the parking gear 70 with longitudinal movement of the parking rod cam 62 and a sprag spring 82 elastically supporting the sprag 80.

The detent lever 54, referring to FIG. 3, is provided with a detent 56 formed to an end of the detent lever 54, and the layout for parking system further includes a detent spring 58 which elastically fixes the detent 56 and is shaped as a plate. Further, the operating power or operating strength of the detent lever 54 may be changed by adjusting length of the detent spring 58.

Referring to FIG. 4, a first protruding portion 66 is integrally formed to the parking rod 60 for preventing the detent lever 54 from being separated from the parking rod 60. For example the first protrude portion 66 is formed by caulking a portion of the parking rod 60 to prevent the detent lever 54 from being separated from the parking rod 60. Thus, the protruding portion 66 is a fairly simple and inexpensive way of preventing the detent lever from separating from the parking rod 60, the production cost and total weight may be reduced.

Referring to FIG. 5, a second protruding portion 68 may be integrally formed to the parking rod 60 for supporting the parking rod spring 64 by for example, by distorting a portion of the parking rod 60 to prevent the parking rod spring 64 from being separated from the parking rod. Again, since the second protruding portion 68 is also a fairly simple and inexpensive way of preventing the parking rod spring 64 from being separated from the parking rod 60, the production cost and total weight may be reduced

Furthermore, and advantageously, the parking unit 50 is not submerged within oil, which is filled within the decelerator housing 10. That is, as shown in FIG. 1, the parking unit 50 is disposed above an oil level (OL) and thus power loss induced by churning may be prevented and sliding of gears may also be prevented.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A layout for parking system of a decelerator for an electric motor vehicle comprising:
a decelerator housing;
an input gear disposed within the decelerator housing;
an output gear disposed within the decelerator housing;
an intermediating gear connecting the input gear and the output gear; and
a parking unit disposed above the input gear and selectively trammeling the intermediating gear.

2. The layout for parking system of decelerator of claim 1, wherein:
the input gear, intermediating gear and the output gear are disposed as the input gear, intermediating gear and the output gear in series, and
centers of the input gear, intermediating gear and the output gear are disposed from a bottom to upward as the centers of the output gear, the input gear and the intermediating gear in series.

3. The layout for parking system of decelerator of claim 1, wherein the parking unit comprises:
a manual lever;
a detent lever coupled to the manual lever and selectively rotating with the manual lever;
a parking rod coupled to the detent lever and provided to be movable with the rotation of the detent lever in the longitudinal direction of the detent lever;
a parking rod cam provided on the parking rod;
a parking rod spring provided on the parking rod and elastically supporting the parking rod;
a parking gear connected to the intermediating gear;
a sprag hinged to the decelerator housing and engaged with the parking gear with longitudinal movement of the parking rod cam; and
a sprag spring elastically supporting the sprag.

4. The layout for parking system of decelerator of claim 3, wherein:
the detent lever is provided with a detent formed to an end of the detent lever, and
the layout for parking system further comprises a detent spring which elastically fixes the detent and is shaped as a plate shape.

5. The layout for parking system of decelerator of claim 3, wherein a first protruding portion is integrally formed to the parking rod for preventing the detent lever from separation from the parking rod.

6. The layout for parking system of decelerator of claim 3, wherein a second protrude portion is integrally formed to the parking rod for supporting the parking rod spring.

7. The layout for parking system of decelerator of claim 3, wherein the parking unit is not submerged within oil, which is filled within the decelerator housing.

8. A layout for parking system of a decelerator for an electric motor vehicle comprising:
a decelerator housing;
an input gear disposed within the decelerator housing;
an output gear disposed within the decelerator housing;
an intermediating gear connecting the input gear and the output gear; and
a parking unit disposed above the input gear and selectively trammeling the intermediating gear,
wherein the parking unit is disposed so as to not be submerged within oil, which is filled within the decelerator housing.

9. The layout for parking system of decelerator of claim 8, wherein:
the input gear, intermediating gear and the output gear are disposed as the input gear, intermediating gear and the output gear in series, and
centers of the input gear, intermediating gear and the output gear are disposed from the bottom to upward as the centers of the output gear, the input gear and the intermediating gear in series
